(19) United States
(12) Patent Application Publication
(10) Pub. No.: US 2015/0229767 A1
(43) Pub. Date: Aug. 13, 2015

(54) SYSTEM AND METHOD FOR ROUTING WORKFLOW ITEMS BASED ON A CHAIN OF ACCOUNTABILITY PROTOCOL

(71) Applicants: Peter Joseph POLACK, Ocala, FL (US); Theresa R. SMITH, San Antonio, TX (US)

(72) Inventors: Peter Joseph POLACK, Ocala, FL (US); Theresa R. SMITH, San Antonio, TX (US)

(21) Appl. No.: 14/620,099

(22) Filed: Feb. 11, 2015

Related U.S. Application Data
(60) Provisional application No. 61/938,596, filed on Feb. 11, 2014.

(51) Int. Cl. H04M 3/523; H04M 3/51

(52) U.S. Cl. CPC H04M 3/5232; H04M 3/5183

(57) ABSTRACT

An adaptable customer service and enterprise workflow management method and system based on a chain of accountability that enables, among other things, ensuring every workflow item is tracked, time-stamped and auditable, and getting every customer request to the right staff member is provided. The system embodies a chain of accountability providing a rigorous workflow management process of one or more workflow item protocols. Each workflow protocol has a defined queue through which the workflow item is routed, wherein each queue has an associated staff member role. The system includes a template of the plurality of workflow protocols that also embodies a method of customizing at least one of the workflow protocols through a process of data analytics, performance benchmarking, administrative modification and reiteration.

### CROSS-REFERENCE TO RELATED APPLICATION

This application claims the benefit of priority of U.S. provisional application No. 61/938,596, filed 11 Feb. 2014, the contents of which are herein incorporated by reference.

### BACKGROUND OF THE INVENTION

The present invention relates to customer service systems and, more particularly, to an adaptable customer service and enterprise workflow management method and system based on a chain of accountability that enables, among other things, ensuring every workflow item is tracked, time-stamped and auditable.

Workflow items take many forms, but are generally initiated by a media interaction, such as a phone call, email of the like. Phone calls are workflow items to the extent that they often act as an entry point to a queue, for subsequent work. Typically an enterprise will have a media interaction protocol for managing in-bound and out-bound phone calls and their subsequent workflow.

Current workflow item management is highly variable, even from customer to customer within the same enterprise, a result of a lack rigor to make them repeatable and standardized. Because of this, staff performance and customer processing has variance that can be modulated. Even though service and product-based enterprises ought to follow a pre-determined and prescriptive process based on their respective service delivery and product functionality limitations, in reality enterprises currently exert little influence on their customer processing protocol execution. Specifically, current customer processing and workflow item routing operates under a blunt triage protocol rubric, wherein the seemingly most pressing workflow item is delegated to the highest ranking staff member.

In the medical professional, for instance, phone triage protocols are standards of practice for delivering medical care. However, there are no standardized protocols for patient phone calls not focused on phone diagnosis and care delivery, yet many patient calls are received where the request does not trigger a triage protocol be executed.

As can be seen, there is a need for an adaptable customer service and enterprise workflow management method and system based on a chain of accountability that enables, among other things, ensuring every workflow item is tracked, time-stamped and auditable, and getting every customer request to the right staff member.

### SUMMARY OF THE INVENTION

In one aspect of the present invention, a system of routing at least one predetermined workflow item through an enterprise having a plurality of staff members, wherein the routing is based on a chain of accountability comprises identifying at least one role for each staff member; constructing at least one workflow queue for the at least one predetermined workflow item; associating each workflow queue with at least one staff member role; documenting a template of protocols for each predetermined workflow item, wherein each template of protocol comprises the at least one workflow queue for each predetermined workflow item; and rigorously routing each predetermined workflow item through the template of protocols documented thereto.

In another aspect of the present invention, a method of customizing the above-mentioned system comprises subjecting one or more of the protocols of the template or protocols to data analytics after a predetermined amount of utilization so that the performance of each subject protocol performance is benchmarked; and administratively modifying each workflow queue and or each staff member roles of each subject protocol, when warranted by the benchmarked performance, whereby situational awareness can be brought to bear on the establishment of a new customized template of protocols comprising each modified subject protocol.

These and other features, aspects and advantages of the present invention will become better understood with reference to the following drawings, description and claims.

### BRIEF DESCRIPTION OF THE DRAWINGS

FIG. 1 is flow chart of an exemplary embodiment of a chain of accountability of the present invention; and

FIG. 2 is a schematic view of an exemplary embodiment of a standardized adaptable process.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an adaptable customer service and enterprise workflow management method and system based on a chain of accountability that enables, among other things, ensuring every workflow item is tracked, time-stamped and auditable, and getting every customer request to the right staff member. The system embodies a chain of accountability providing a rigorous workflow management process of one or more workflow item protocols. Each workflow protocol has a defined queue through which the workflow item is routed, wherein each queue has an associated staff member role. The system includes a template of the plurality of workflow protocols that also embodies a method of customizing at least one of the workflow protocols through a process of data analytics, performance benchmarking, administrative modification and reiteration.

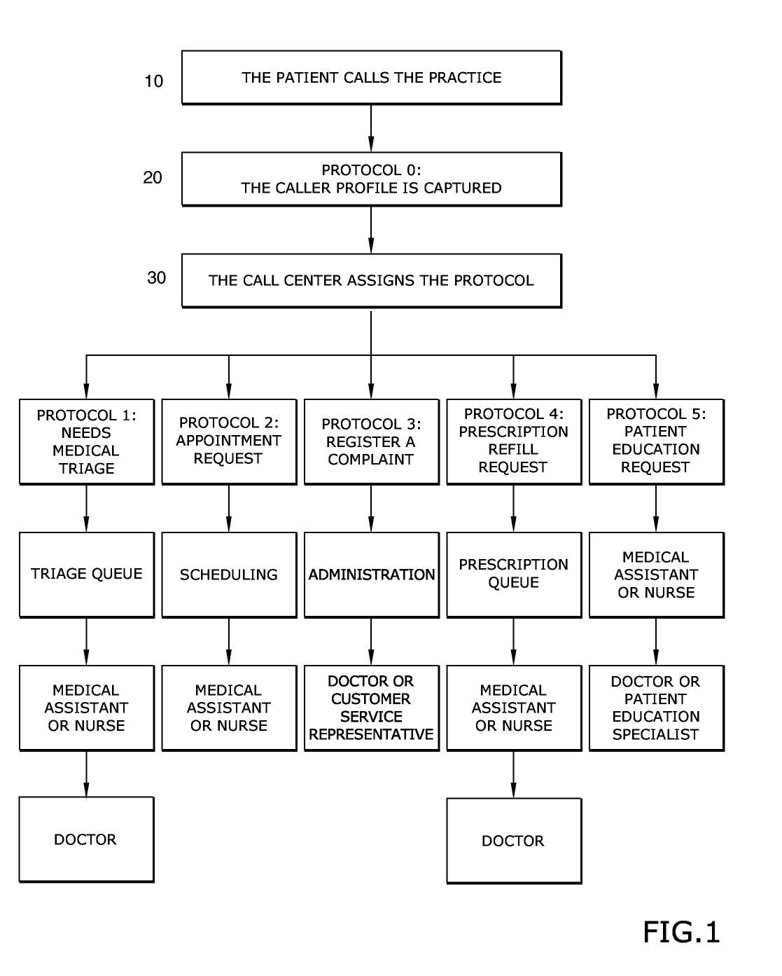

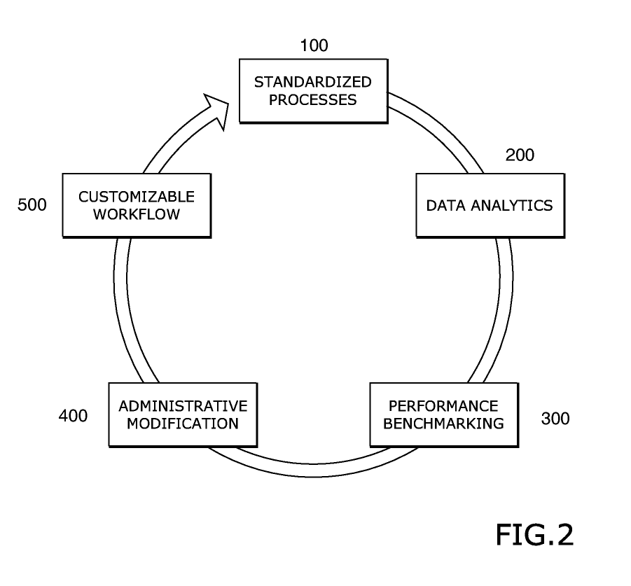

Referring to FIGS. 1 and 2, the present invention include an adaptable customer service and enterprise workflow management method and system based on a chain of accountability that enables, among other things, ensuring every workflow item is tracked, time-stamped and auditable, and getting every customer request to the right staff member. Each enterprise may have a plurality of sub-organizations, wherein each sub-organization has a plurality of staff members, each with different identifiable roles and responsibilities.

FIG. 1 illustrates the chain of accountability that provides a rigorous, enforceable workflow item management process so as to eliminate variability within and between sub-organizations across an enterprise, while enabling adaptive administrative modifications as needed. By requiring that workflow items in all sub-organizations are routed according to the chain of accountability, all such workflow items can be tracked, time-stamped and audited across the enterprise. Regardless of the complexity of the workflow process and management, the application of the chain of accountability maintains the cross-enterprise veracity.

The chain of accountability may include a customizable template. The customizable template may include a plurality of workflow protocols or processes, wherein each workflow process defines one or more queues for the workflow item to be routed through; and linking each queue to a staff member role.

Each queue and/or staff member role may be redefined or adapted to create a new workflow process or protocol, whereby the template is customizable to new situations and new customers.

Specifically, customization of existing workflow process may include the following method, as illustrated in FIG. 2: in step 100 the protocols of an existing customizable template may be standardized through their repeatable utilization. Said standardized protocols may be subject to statistically relevant data analytics after a predetermined amount of utilization, in step 200, whereby the performance of each standardized protocol may be benchmarked and evaluated, in step 300. After review of the performance benchmarking, in step 400, administrative modifications may be made by redefining and/or adapting the queues and staff member roles thereof, whereby situational awareness can be brought to bear on the establishment of a new customized workflow process, in step 500. As a result, a new customized template including the new customized workflow process is standardized in new step 100.

As illustrated in FIG. 1, an exemplary chain of accountability is established within a medical services enterprise, “a practice.” A customer/patient may call into the practice call center in step 10. In step 20, a plurality of patient information may be collected so as to define a patient profile. In certain embodiments, the patient profile may include a predetermined caller profile for ascertaining whether an incoming phone call into a medial practice is one or more predetermined workflow item. Based on, at least in part, the patient profile the call center associates the call with a work item and one or more related work queues through which such work item may flow, in step 30. The one or more queue may include a need for medical triage, protocol 1; an appointment request, protocol 2; a registration of a complaint, protocol 3; a prescription refill request, protocol 4; and/or a patient education request, protocol 5. Each queue has one or more staff member role associated with it; for example, protocol 2 has a medical assistant or nurse associated with it. Each designated staff member role may have a unique time-stamp and/or tracking number associated with it for auditing purposes.

Some queues have sub-queues, for example Protocol 1 queue allows for immediate direction of a call into a medical triage queue so that the right staff member gets the patient.

In certain embodiments, the present invention may be used by operators in non-medical enterprises, including financial institutions, governmental services, information technologies and the like.

It should be understood, of course, that the foregoing relates to exemplary embodiments of the invention and that modifications may be made without departing from the spirit and scope of the invention as set forth in the following claims.

What is claimed is:

1. A system of routing at least one predetermined workflow item through an enterprise having a plurality of staff members, wherein the routing is based on a chain of accountability, comprising:
identifying at least one role for each staff member;
constructing at least one workflow queue for the at least one predetermined workflow item;
associating each workflow queue with at least one staff member role;
documenting a template of protocols for each predetermined workflow item, wherein each template of protocol comprises the at least one workflow queue for each predetermined workflow item; and
rigorously routing each predetermined workflow item through the template of protocols documented thereto.

2. The system of claim 1, wherein each predetermined workflow item is a phone call.

3. The system of claim 2, further including defining a predetermined caller profile for ascertaining whether an incoming phone call is one or more predetermined workflow item.

4. The system of claim 3, wherein the enterprise is a medical practice.

5. The system of claim 4, wherein the template of protocols comprises at least one of the following workflow items: a needs medical triage, an appointment request, a register complaint, a prescription refill request, and a patient education request.

6. The system of claim 5, wherein the needs medical triage workflow item is constructed of a triage queue.

7. The system of claim 6, wherein the triage queue is associated with at least one of the following staff member role: a medical assistant, a nurse, and a doctor.

8. The system of claim 5, wherein the appointment request workflow item is constructed of a scheduling queue.

9. The system of claim 8, wherein the scheduling queue is associated with at least one of the following staff member role: a medical assistant and a nurse.

10. The system of claim 5, wherein the register a complaint workflow item is constructed of an administration queue.

11. The system of claim 10, wherein the administration queue is associated with at least one of the following staff member role: a doctor and a customer service representative.

12. The system of claim 5, wherein the prescription refill request workflow item is constructed of a prescription queue.

13. The system of claim 12, wherein the prescription queue is associated with at least one of the following staff member role: a medical assistant, a nurse, and a doctor.

14. The system of claim 5, wherein the patient education request workflow item is constructed of a medical assistant or nurse queue.

15. The system of claim 12, wherein the prescription queue is associated with at least one of the following staff member role: a patient education specialist and a doctor.

16. A method of customizing the system of claim 1, comprising:
subjecting one or more of the protocols of the template or protocols to data analytics after a predetermined amount of utilization so that the performance of each subject protocol performance is benchmarked; and
administratively modifying each workflow queue and or each staff member roles of each subject protocol, when warranted by the benchmarked performance,
whereby situational awareness can be brought to bear on the establishment of a new customized template of protocols comprising each modified subject protocol.
